(19) United States
(12) Patent Application Publication
(10) Pub. No.: US 2026/0358210 A1
(43) Pub. Date: Nov. 12, 2026

(54) TEMPERATURE CONTROL IN A CHARGED AEROSOL DETECTOR

(71) Applicant: Dionex Softron GmbH, Germering (DE)

(72) Inventor: Benjamin Eggart, Munich (DE)

(21) Appl. No.: 19/202,399

(22) Filed: May 8, 2025

(51) Int. Cl. G01N 1/44; B01D 15/10; G01N 30/02; G01N 30/64

(52) U.S. Cl. CPC G01N 1/44; B01D 15/102; G01N 30/64; G01N 2030/027

(57) ABSTRACT

The present invention relates to a method for controlling temperatures in a CAD system comprising a plurality of aerosol-handling components which are temperature controlled based on a respective temperature setpoint, the method comprising: setting a primary temperature setpoint T_{P}; setting at least one dependent temperature setpoint based on the primary temperature setpoint; and stabilizing temperatures of the temperature-controlled aerosol-handling components according to associated temperature setpoints. Furthermore, the present inventio relates to a respective CAD system and computer program product.

The present invention generally relates to the field of charged aerosol detection and particularly to an improved temperature control of the aerosol in a charged aerosol detector (CAD). The invention is applicable to the field of chromatography, such as liquid chromatography (LC) and particularly to the field of analyte detection for High Performance Liquid Chromatography (HPLC) and Ultra-High Performance Liquid Chromatography (UHLPC).

Charged aerosol detection is an analytical technique used in chromatography. In particular, CAD is a detection method capable of quantifying a given constituent (or a plurality of constituents) in a sample upon creating charged aerosol particles, which are analyzed using an ampere meter (ammeter). CAD methods are commonly used to quantify non-volatile and semi-volatile analytes, and can provide a consistent analyte response independent of chemical structures and molecule sizes.

Very generally, an eluent may be nebulized to provide a primary aerosol. Subsequently large droplets may be removed to provide a secondary aerosol which may then be guided through an evaporation tube to dry the aerosol droplets and thus provide aerosol particles. The aerosol particles may then be charged and subsequently detected, e.g. using an ammeter.

Typically, the evaporation tube (also referred to as drying tube) may be operated at a standard temperature value and subsequent components of the CAD-detector may be stabilized to temperatures above said standard temperature, wherein respective stabilization temperatures may increase in a downstream direction. This way a respective positive temperature gradient may be realized such that a potentially eluent-saturated gas atmosphere does ideally not condense again. This may be particularly relevant since the dried aerosol particles may additionally favour recondensation.

However, the evaporation tube may typically allow to be operated at a wide range of temperatures different than the respective standard value, e.g. to allow for faster and/or more thorough drying of droplets. However, operating the evaporation tube above the standard temperature value may disadvantageously lead to undesired recondensation since downstream components of the detector are temperature stabilized to fixed values. In particular, there may be a negative temperature gradient between evaporation tube and subsequent detection.

In light of the above, it is an object to overcome or at least alleviate the shortcomings and disadvantages of the prior art.

These objects are met by the present invention.

In a first aspect, the present invention relates to a method for controlling temperatures in a CAD system comprising a plurality of aerosol-handling components which are temperature controlled based on a respective temperature setpoint, the method comprising: setting a primary temperature setpoint T_{P}; setting at least one dependent temperature setpoint based on the primary temperature setpoint; and stabilizing temperatures of the temperature-controlled aerosol-handling components according to associated temperature setpoints.

Thus, the at least one dependent temperature setpoint depends on the primary temperature setpoint. This may advantageously allow for a automatically coordinated temperature control based on a single, primary temperature setpoint, which may for example be set by a user. Thus, the present invention may advantageously allow to maintain a desired temperature gradient throughout the CAD system even if the primary temperature setpoint is adjusted.

It will be understood that when reference is made to “temperature setpoints” both, the primary and the at least one dependent temperature setpoint are meant.

Setting a primary temperature setpoint may comprise receiving the primary temperature setpoint. For example, setting the primary temperature setpoint may comprise a user providing the primary temperature setpoint. That is, a user may choose a desired primary temperature setpoint, e.g. based on an analyte to be measured. The primary temperature setpoint may for example be the temperature setpoint for a drying tube of the CAD.

The method may comprise setting a temperature offset Δ_{T}. Setting the temperature offset Δ_{T} may comprise receiving the temperature offset Δ_{T}. For example, setting the temperature offset Δ_{T} may comprise a user providing the temperature offset Δ_{T}. The temperature offset Δ_{T} may be in a range of −15 °C to 15 °C, preferably −10 °C to 10 °C, more preferably −5 °C to +5 °C. That is, while the temperature offset may typically be positive in order to provide for a positive temperature gradient in an aerosol flow direction of the CAD, which may serve to reduce the risk of recondensation, it may also be negative. Thus, it may also be possible to provide a controlled, negative temperature gradient in the aerosol flow direction of the CAD. This may be desirable for specific cases, e.g. when analysing volatile analytes, where it may for example allow to avoid further evaporation downstream of the drying tube. Due to the carefully controlled negative temperature gradient, the risk of recondensation may at least be controlled and ideally reduced compared to state of the art systems.

Setting the at least one dependent temperature setpoint may further be based on the temperature offset Δ_{T}.

The at least one dependent temperature setpoint may be set such that temperature setpoints associated with aerosol-handling components that are adjacent in aerosol flow direction differ by the temperature offset Δ_{T}.

Setting the at least one dependent temperature setpoint may comprise establishing a respective pre-defined temperature difference between the primary temperature setpoint and the at least one dependent temperature setpoint. It will be understood that the respective pre-defined temperature difference may be different for each of the at least one dependent temperature setpoints. The pre-defined temperature difference may be a multiple of the temperature offset Δ_{T}, but different from zero.

The temperature setpoints may be set such that the temperature of temperature-controlled aerosol-handling components increases in an aerosol flow direction. In other words, the temperature setpoints may be set such that a positive temperature gradient is established throughout the temperature-controlled aerosol-handling components in the aerosol flow direction

The step of setting at least one dependent temperature setpoint may be performed automatically. That is, the at least one dependent temperature may preferably be automatically set based on the primary temperature set point.

The method may comprise establishing a temperature gradient between the temperature-controlled aerosol-handling components in an aerosol flow direction. The temperature gradient may be a positive temperature gradient. Alternatively, the temperature gradient may be a negative temperature gradient. That is, the method may comprise establishing a positive or a negative temperature gradient. Generally, a positive temperature gradient may be preferred as it may advantageously allow to reduce the risk of recondensation. However, in certain case, e.g. when working with volatile analytes, a negative temperature gradient may be preferred in order to avoid (or at least reduce) evaporation of the analyte downstream of the during tube. In any case, the method may advantageously maintain the desired gradient whenever the primary temperature setpoint is altered.

The method may further comprise performing at least one measurement once the temperatures of the temperature-controlled aerosol-handling components are stabilized to the associated temperature setpoints.

The CAD system may preferably comprise a temperature-independent ampere meter. In such a case, a temperature of the ampere meter may not be stabilized. Additionally or alternatively, the method may comprise measuring a current with the ampere meter to determine a quantity of aerosol particles once the temperatures of the temperature-controlled aerosol-handling components are stabilized to the associated temperature setpoints.

The temperature-controlled aerosol-handling components may comprise a drying tube and wherein the drying tube may be temperature-controlled based on a vaporization temperature setpoint T_{V} of a drying-tube temperature controller. The primary temperature setpoint may preferably be the vaporization temperature setpoint T_{V}.

The temperature-controlled aerosol-handling components may comprise a mixing chamber, an ion trap, and a collector. In particular, the system may comprise a detection assembly comprising the mixing chamber, the ion trap, an ionizer, and the collector. The detection assembly may be temperature-controlled based on a single detection temperature setpoint T_{D} of a detection temperature controller. The at least one dependent temperature setpoint may comprise the detection temperature setpoint T_{D}. Setting the at least one dependent temperature setpoint may comprise setting the temperature setpoints such that T_{D}=T_{V}+Δ_{T}.

Alternatively, the mixing chamber may be temperature-controlled based on a mixing-chamber temperature setpoint T_{M}; the ion trap may be temperature-controlled based on an ion-trap temperature setpoint T_{I}; and the collector may be temperature-controlled based on a collector temperature setpoint T_{C}. The at least one dependent temperature setpoint may comprise the mixing-chamber temperature setpoint T_{M}, the ion-trap temperature setpoint T_{I}, and collector temperature setpoint T_{C}. Setting the at least one dependent temperature setpoint may comprise setting the temperature setpoints such that T_{M}=T_{V}+Δ_{T}, T_{I}=T_{M}+Δ_{T}, and T_{C}=T_{I}+Δ_{T}.

The ionizer may be temperature-controlled based on an ionizer temperature setpoint T_{L}. The at least one dependent temperature setpoint may comprise the ionizer temperature setpoint T_{L}. The vaporization temperature setpoint T_{V} may lie in the range of 5 °C to 100 °C.

In another aspect, the present invention relates to a CAD system comprising a drying tube, a detection assembly comprising a mixing chamber, an ionizer, an ion trap, and a collector; an ampere meter; and a temperature control system comprising at least two temperature controllers, wherein the temperature control system is configured to automatically control temperatures of the drying tube and the detection assembly and/or components thereof to provide a temperature gradient therebetween in a downstream direction.

The system may be configured to perform the method according to the present invention as for example described above.

The temperature control system may be configured to perform the method according to the present invention as for example described above.

The ampere meter may preferably be temperature independent.

The gradient may be a positive gradient. That is, the temperature may increase in the downstream direction. Alternatively, the gradient may be a negative gradient. That is, the temperature may decrease in the downstream direction.

The temperature control system may comprise a drying-tube temperature control configured to control a drying-tube temperature based on a vaporization temperature setpoint T_{V}.

The temperature control system may comprise a detection temperature control configured to control a detection temperature based on a detection temperature setpoint TD. The temperature control system may be configured to automatically adjust the detection temperature setpoint TD based on the vaporisation temperature setpoint TV. The detection temperature control may be operatively connected to the drying-tube temperature control.

The temperature control system may comprise a mixing-chamber temperature control configured to control a mixing-chamber temperature based on a mixing-chamber temperature setpoint T_{M}. The temperature control system may be configured to automatically adjust the mixing-chamber temperature setpoint T_{M} based on the vaporisation temperature setpoint T_{V}. The mixing-chamber temperature control may be operatively connected to the drying-tube temperature control.

The temperature control system may comprise an ion-trap temperature control configured to control an ion-trap temperature based on an ion-trap temperature setpoint T_{I}. The temperature control system may be configured to automatically adjust the ion-trap temperature setpoint T_{I} based on the vaporisation temperature setpoint T_{V}. The ion-trap temperature control may be operatively connected to the drying-tube temperature control.

The temperature control system may comprise a collector temperature control configured to control a collector temperature based on a collector temperature setpoint T_{C}. The temperature control system may be configured to automatically adjust the collector temperature setpoint T_{C} based on the vaporisation temperature setpoint T_{V}. The collector temperature control may be operatively connected to the drying-tube temperature control.

The detection assembly may further comprise an ionizer. The temperature control system may comprise an ionizer temperature control configured to control an ionizer temperature based on an ionizer temperature setpoint T_{L}. The temperature control system may be configured to automatically adjust the ionizer temperature setpoint T_{L} based on the vaporisation temperature setpoint T_{V}. The ionizer temperature control may be operatively connected to the drying-tube temperature control.

The system may further comprise an effluent inlet, a gas inlet, a nebulizer, a spray chamber, and a drain.

The at least two temperature controllers of the temperature system may be operatively connected to each other.

In another aspect, the present invention relates to a computer program product comprising instructions which, when the program is executed by a CAD system according to the present invention (as for example descried above), cause the CAD system to carry out the method according to the present invention (as for example described above).

Similarly, the present invention relates to a computer program product comprising instructions which, when the program is executed by the temperature control system of a CAD system according to the present invention (as for example descried above), cause the temperature control system to carry out the method according to the present invention (as for example described above).

Below, reference will be made to method embodiments. These embodiments are abbreviated by the letter “M” followed by a number. Whenever reference is herein made to “method embodiments”, these embodiments are meant.

M1. Method for controlling temperatures in a CAD system comprising a plurality of aerosol-handling components which are temperature controlled based on a respective temperature setpoint, the method comprising:
setting a primary temperature setpoint T_{P};
setting at least one dependent temperature setpoint based on the primary temperature setpoint; and
stabilizing temperatures of the temperature-controlled aerosol-handling components according to associated temperature setpoints.

Thus, the at least one dependent temperature setpoint depends on the primary temperature setpoint.

It will be understood that when reference is made to “temperature setpoints” both, the primary and the at least one dependent temperature setpoint are meant.

M2. The method according to the preceding method embodiment, wherein setting the primary temperature setpoint comprises receiving the primary temperature setpoint.

M3. The method according to any of the 2 preceding method embodiments, wherein setting the primary temperature setpoint comprises a user providing the primary temperature setpoint.

M4. The method according to any of the preceding method embodiments, wherein the method comprises setting a temperature offset Δ_{T}.

M5. The method according to the preceding method embodiment, wherein setting the temperature offset Δ_{T} comprises receiving the temperature offset Δ_{T}.

M6. The method according to any of the 2 preceding method embodiments, wherein setting the temperature offset Δ_{T} comprises a user providing the temperature offset Δ_{T}.

M7. The method according to any of the 3 preceding method embodiments, wherein the temperature offset Δ_{T} is in a range of −15 °C to 15 °C, preferably −10 °C to 10 °C, more preferably −5 °C to +5 °C.

M8. The method according to any of the 4 preceding method embodiments, wherein setting the at least one dependent temperature setpoint is further based on the temperature offset Δ_{T}.

M 9. The method according to any of the 5 preceding method embodiments, wherein the at least one dependent temperature setpoint is set such that temperature setpoints associated with aerosol-handling components that are adjacent in aerosol flow direction differ by the temperature offset Δ_{T}.

M10. The method according to any of the preceding method embodiments, wherein setting the at least one dependent temperature setpoint comprises establishing a respective pre-defined temperature difference between the primary temperature setpoint and the at least one dependent temperature setpoint.

It will be understood that the respective pre-defined temperature difference may be different for each of the at least one dependent temperature setpoints.

M11. The method according to the preceding method embodiment and with the features of M4, wherein the pre-defined temperature difference is a multiple of the temperature offset Δ_{T}, but different from zero.

M12. The method according to any of the preceding method embodiments, wherein the temperature setpoints are set such that the temperature of temperature-controlled aerosol-handling components increases in an aerosol flow direction.

M13. The method according to any of the preceding method embodiments, wherein the step of setting at least one dependent temperature setpoint is performed automatically.

M14. The method according to any of the preceding method embodiment, wherein the method comprises establishing a temperature gradient between the temperature-controlled aerosol-handling components in an aerosol flow direction.

M15. The method according to the preceding method embodiment, wherein the temperature gradient is a positive temperature gradient.

M16. The method according to the penultimate method embodiment, wherein the temperature gradient is a negative temperature gradient.

M17. The method according to any of the preceding method embodiments, wherein the method further comprises performing at least one measurement once the temperatures of the temperature-controlled aerosol-handling components are stabilized to the associated temperature setpoints.

M18. The method according to any of the preceding method embodiments, wherein the CAD system comprises a temperature-independent ampere meter.

M19. The method according to the preceding method embodiments, wherein a temperature of the ampere meter is not stabilized.

M20. The method according to any of the 2 preceding method embodiments, wherein the method comprises measuring a current with the ampere meter to determine a quantity of aerosol particles once the temperatures of the temperature-controlled aerosol-handling components are stabilized to the associated temperature setpoints.

M21. The method according to any of the preceding method embodiments, wherein the temperature-controlled aerosol-handling components comprise a drying tube and wherein the drying tube is temperature-controlled based on a vaporization temperature setpoint T_{V} of a drying-tube temperature controller.

M22. The method according to the preceding method embodiment, wherein the primary temperature setpoint is the vaporization temperature setpoint T_{V}.

M23. The method according to any of the preceding method embodiments, wherein the temperature-controlled aerosol-handling components comprise a mixing chamber, an ion trap, and a collector.

M24. The method according to the preceding method embodiment, wherein the system comprises a detection assembly comprising the mixing chamber, the ion trap, an ionizer, and the collector.

M25. The method according to the preceding method embodiment, wherein the detection assembly is temperature-controlled based on a single detection temperature setpoint T_{D} of a detection temperature controller.

M26. The method according to the preceding method embodiment, wherein the at least one dependent temperature setpoint comprises the detection temperature setpoint T_{D}.

M27. The method according to the any of the 2 preceding embodiments and with the features of M4 and M21, wherein setting the at least one dependent temperature setpoint comprises setting the temperature setpoints such that T_{D}=T_{V}+Δ_{T}.

M28. The method according to M20, wherein the mixing chamber is temperature-controlled based on a mixing-chamber temperature setpoint T_{M};
the ion trap is temperature-controlled based on an ion-trap temperature setpoint T_{I}; and
the collector is temperature-controlled based on a collector temperature setpoint T_{C}.

M29. The method according to the preceding method embodiment, wherein the at least one dependent temperature setpoint comprises the mixing-chamber temperature setpoint T_{M}, the ion-trap temperature setpoint T_{I}, and collector temperature setpoint T_{C}.

M30. The method according to any of the 2 preceding method embodiments and with the features of M4 and M21, wherein setting the at least one dependent temperature setpoint comprises setting the temperature setpoints such that T_{M}=T_{V}+Δ_{T}, T_{I}=T_{M}+Δ_{T}, and T_{C}=T_{I}+Δ_{T}.

M31. The method according to any of the 3 preceding method embodiments, wherein the ionizer is temperature-controlled based on an ionizer temperature setpoint T_{L}.

M32. The method according to the preceding method embodiment, wherein the at least one dependent temperature setpoint comprises the ionizer temperature setpoint T_{L}.

M33. The method according to any of the preceding method embodiments and with the features of M21, wherein the vaporization temperature setpoint T_{V} lies in the range of 5 °C to 100 °C.

Below, reference will be made to CAD system embodiments. These embodiments are abbreviated by the letter “S” followed by a number. Whenever reference is herein made to “system embodiments”, these embodiments are meant.

S1. A CAD system, comprising
a drying tube;
a detection assembly comprising a mixing chamber, an ionizer, an ion trap, and a collector;
an ampere meter; and
a temperature control system comprising at least two temperature controllers, wherein the temperature control system is configured to automatically control temperatures of the drying tube and the detection assembly and/or components thereof to provide a temperature gradient therebetween in a downstream direction.

S2. The CAD system according to the preceding system embodiment, wherein the system is configured to perform the method according to any of the preceding method embodiments.

S3. The CAD system according to any of the preceding system embodiments, wherein the temperature control system is configured to perform the method according to any of the preceding method embodiments.

S4. The CAD system according to any of the preceding system embodiments, wherein the ampere meter is temperature independent.

S5. The CAD system according to any of the preceding system embodiments, wherein the gradient is a positive gradient.

S6. The CAD system according to any of S1 to S4, wherein the gradient is a negative gradient.

S7. The CAD system according to any of the preceding system embodiments, wherein the temperature control system comprises a drying-tube temperature control configured to control a drying-tube temperature based on a vaporization temperature setpoint TV.

S8. The CAD system according to any of the preceding system embodiments, wherein the temperature control system comprises a detection temperature control configured to control a detection temperature based on a detection temperature setpoint TD.

S9. The CAD system according to the preceding system embodiment and with the features of S7, wherein the temperature control system is configured to automatically adjust the detection temperature setpoint T_{D} based on the vaporisation temperature setpoint T_{V}.

S10. The CAD system according to any of the 2 preceding system embodiments and with the features of S7, wherein the detection temperature control is operatively connected to the drying-tube temperature control.

S11. The CAD system according to any of the preceding system embodiments, wherein the temperature control system comprises a mixing-chamber temperature control configured to control a mixing-chamber temperature based on a mixing-chamber temperature setpoint T_{M}.

S12. The CAD system according to the preceding system embodiment and with the features of S7, wherein the temperature control system 300 is configured to automatically adjust the mixing-chamber temperature setpoint T_{M} based on the vaporisation temperature setpoint T_{V}.

S13. The CAD system according to any of the 2 preceding system embodiments and with the features of S7, wherein the mixing-chamber temperature control is operatively connected to the drying-tube temperature control.

S14. The CAD system according to any of the preceding system embodiments, wherein the temperature control system comprises an ion-trap temperature control configured to control an ion-trap temperature based on an ion-trap temperature setpoint T_{I}.

S15. The CAD system according to the preceding system embodiment and with the features of S7, wherein the temperature control system is configured to automatically adjust the ion-trap temperature setpoint T_{I} based on the vaporisation temperature setpoint T_{V}.

S16. The CAD system according to any of the 2 preceding system embodiments and with the features of S7, wherein the ion-trap temperature control is operatively connected to the drying-tube temperature control.

S17. The CAD system according to any of the preceding system embodiments, wherein the temperature control system comprises a collector temperature control configured to control a collector temperature based on a collector temperature setpoint T_{C}.

S18. The CAD system according to the preceding system embodiment and with the features of S7, wherein the temperature control system is configured to automatically adjust the collector temperature setpoint T_{C} based on the vaporisation temperature setpoint T_{V}.

S19. The CAD system according to any of the 2 preceding system embodiments and with the features of S7, wherein the collector temperature control is operatively connected to the drying-tube temperature control.

S20. The CAD system according to any of the preceding system embodiments, wherein the detection assembly further comprises an ionizer.

S21. The CAD system according to the preceding system embodiment, wherein the temperature control system comprises an ionizer temperature control configured to control an ionizer temperature based on an ionizer temperature setpoint T_{L}.

S22. The CAD system according to the preceding system embodiment and with the features of S7, wherein the temperature control system is configured to automatically adjust the ionizer temperature setpoint T_{L} based on the vaporisation temperature setpoint T_{V}.

S23. The CAD system according to any of the 2 preceding system embodiments and with the features of S7, wherein the ionizer temperature control is operatively connected to the drying-tube temperature control.

S24. The CAD system according to any of the preceding system embodiments, the system further comprising an effluent inlet, a gas inlet, a nebulizer, a spray chamber, and a drain.

S25. The CAD system according to any of the preceding system embodiments, wherein the at least 2 temperature controllers of the temperature system are operatively connected to each other.

Below, reference will be made to computer program product embodiments. These embodiments are abbreviated by the letter “C” followed by a number. Whenever reference is herein made to “program embodiments”, these embodiments are meant.

C1. Computer program product comprising instructions which, when the program is executed by a CAD system according to any of the preceding system embodiments, cause the CAD system to carry out the method according to any of the preceding method embodiments.

C2. Computer program product comprising instructions which, when the program is executed by the temperature control system of a CAD system according to any of the preceding system embodiments, cause the temperature control system to carry out the method according to any of the preceding method embodiments.

Embodiments of the present invention will now be described with reference to the accompanying drawings. These embodiments should only exemplify, but not limit, the present invention.

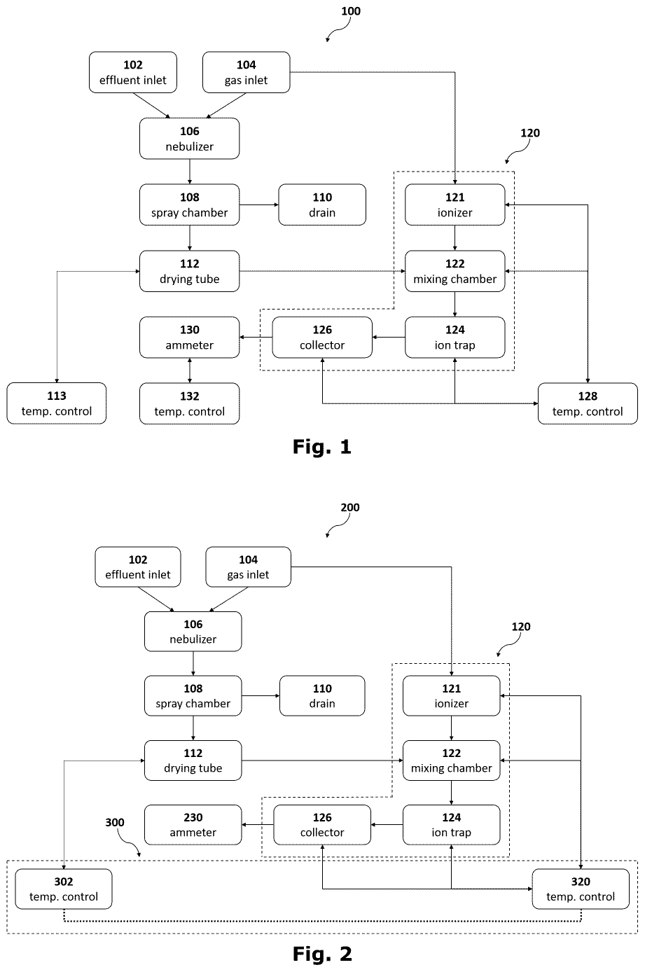

FIG. 1 Depicts a Common Cad System;

FIG. 2 depicts an embodiment of a CAD system according to the present invention;

FIG. 3 depicts another embodiment of a CAD system according to the present invention;

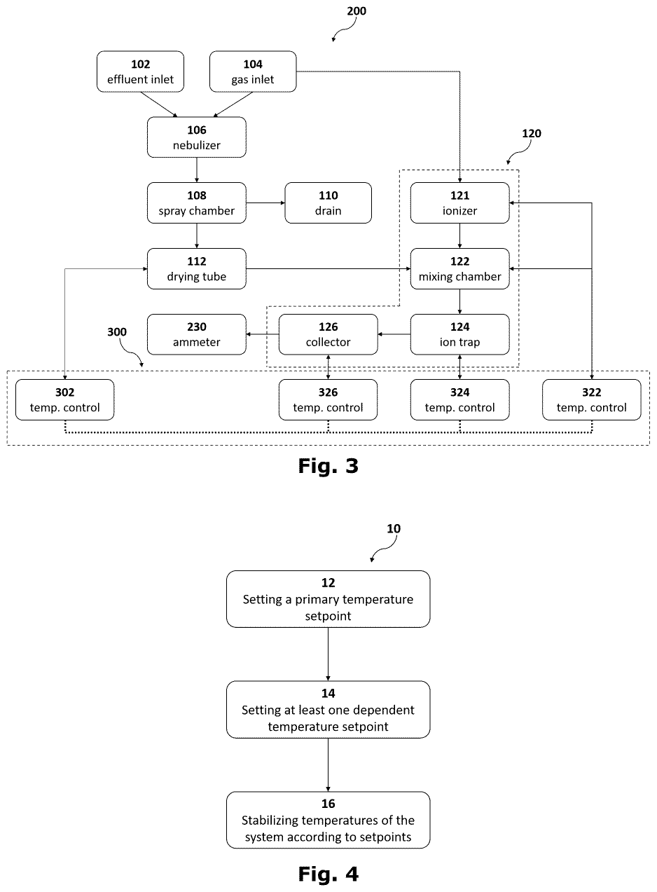

FIG. 4 depicts an embodiment of a method according to the present invention; and

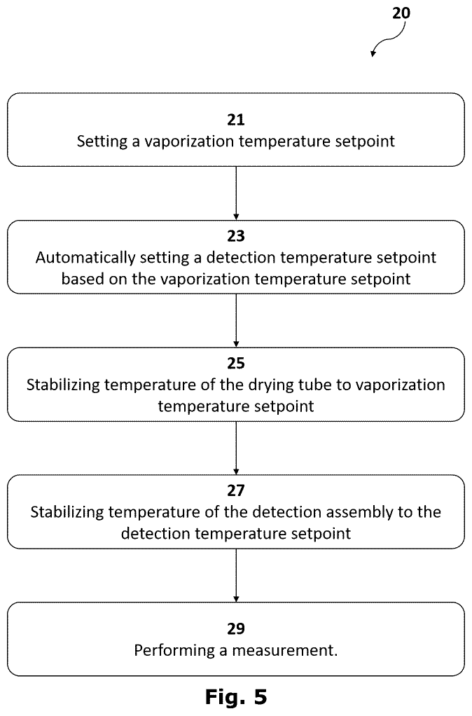

FIG. 5 depicts another embodiment of a method according to the present invention;

It is noted that not all the drawings carry all the reference signs. Instead, in some of the drawings, some of the reference signs have been omitted for the sake of brevity and simplicity of illustration. Embodiments of the present invention will now be described with reference to the accompanying drawings.

FIG. 1 schematically illustrates a CAD system 100, which may also simply be referred to as system 100. Generally, the system 100 comprises an effluent inlet 102 at which a respective chromatography effluent (also simply referred to as effluent) may be received, and a gas inlet 104 for supplying the system with a gas, preferably an inert gas (such as nitrogen (N₂)). Fluid flows from the effluent inlet 102 and the gas inlet 104 are combined in a nebulizer 106, which generates a primary aerosol, i.e. a spray of fine droplets of effluent.

Generally, a chromatography effluent or simply effluent may denote a liquid flowing out of a chromatography column. In other words, it may refer to the mobile phase (or eluent) that carries separated constituents of the sample (analyte) to be analyzed. In many cases, it comprises constituents of the sample and a solvent mixture. The eluent, or mobile phase, also transports the analyte (the substance to be measured) through the chromatographic system.

The nebulizer 106 is fluidly connected to a spray chamber 108. That is, the primary aerosol may be sprayed directly into the spray chamber 108, wherein larger droplets are separated and provided to drain 110, e.g. a drain pump 110. The resulting aerosol, which may typically be referred to as secondary aerosol, is then guided through a drying tube 112, also referred to as evaporation tube 112, wherein the secondary aerosol droplets are dried to form particles.

The aerosol particles are then guided into a mixing chamber 122 wherein the particles are mixed with ionized gas provided by an ionizer 121, which may also be supplied with gas by the gas inlet 104. The ionizer 121 may be comprised by the mixing chamber 122, i.e. it may form part of and/or be located within the mixing chamber 122. The ionizer may also be referred to as charger 121. The particles may be charged via diffusion and remaining ions may subsequently be removed in an ion trap 124, before the charged particles are collected in a collector 126, e.g. a Faraday cup 126, and a resulting current is measured with an ampere meter 130.

The combination of mixing chamber 122, ionizer 121, ion trap 124 and collector 126 may also be referred to as detection assembly 120.

More specifically, the principle of charged aerosol detection involves a series of steps that convert an effluent stream (typically comprising eluent and analyte) into a detectable signal.

Initially a primary aerosol may be formed from an effluent stream and a gas stream, provided by the effluent inlet 102 and gas inlet 104, respectively. The effluent stream may be atomized, preferably pneumatically atomized, in the spray chamber 108 using a respective nebulizer 106. That is, the effluent stream may be converted into a primary aerosol comprising droplets. The gas flow for atomisation may also automatically provide the transport atmosphere for the generated aerosol through the entire detector (i.e. CAD system). The generation of the primary aerosol may be crucial as it may split the effluent and the analyte it contains into droplets of a specific size distribution. For example, pneumatic atomisation may lead to a logarithmically normal distribution of droplet sizes. The size of the droplets may largely be determined by the physical properties (especially surface tension, viscosity, and density) of the liquid, e.g. the eluent. The analyte may still be present in the droplets according to its concentration.

After the primary aerosol is generated, the droplets may undergo a process known as aerosol conditioning. During this process, droplets that are too large (e.g. ~10 μm or larger) may be removed by hitting a wall opposite the pneumatic nebuliser 106. More specifically, the geometry of the spray chamber 108 may be designed in such a way that large droplets may be too slow to follow the gas flow. This may advantageously narrow down the particle distribution and lead to the remaining droplets being of a suitable size for further processing. In addition, a large part of the eluent volume may be separated, ideally enabling that all droplets can be dried to particles in the next process step. The separated eluent may for example be pumped out via a drainage pump 110 in a lower area of the spray chamber 108 without affecting an overpressure typically present in the CAD, which may be around 200 mbar.

The so conditioned secondary aerosol may then be subjected to vaporisation. In the so-called drying tube 112 the moist droplets may vaporise into solid particles. These particles may comprise (e.g. consist of) non-volatile background impurities of the effluent, and the analyte. The size of the dried particles may be proportional to a concentration of the analyte since the analyte may generally be present in the droplets proportional to its general concentration. High analyte concentrations may lead to large particles, while low concentrations may lead to correspondingly smaller particles. The size distribution of the droplets may remain unaffected by the drying process. The individual particle size may therefore result only from the concentration of the analyte and its density.

In an aerosol charging phase, the particles may then be charged by diffusion charging in the mixing chamber 122. The number of charges on the aerosol particles may depend on the particle size, i.e. the available surface area. The total charge carried by the aerosol can then be measured with an ammeter 130 as a current originating from charged particles being collected in a Farraday cup 126. This current may be directly proportional to the mass of the analyte and may provide a quantitative measurement of the analyte present in the original sample.

A drying-tube temperature for drying the secondary moist aerosol can typically be continuously adjusted from 5 to 100 °C. That is, the drying tube 112 may generally be stabilized to a desired vaporization temperature setpoint T_{V} which may lie in the range of 5 °C to 100 °C. The system 100 may comprise a drying-tube temperature control 113, which may be configured to control the temperature of the drying tube 112 and stabilize it to the respective vaporization temperature setpoint T_{V}. The default vaporization temperature setpoint may for example typically be T_{V}=35 °C. It will be understood that the term drying-tube temperature may generally denote the temperature of the drying tube 112, while the vaporization temperature setpoint T_{V} may denote the respective temperature setpoint for the drying-tube temperature control 113. Typically, when the drying-tube temperature control 113 is operating the drying-tube temperature may basically correspond to the vaporization temperature setpoint (apart from errors due to measurement uncertainties and manufacturing precision).

The downstream unit, where the particles are charged and detected, i.e. the detection assembly 120, may typically be temperature-controlled to 40 °C. That is, the system 100 may comprise a detection temperature control 128, which may be configured to control and stabilize the temperature of the detection assembly 120 to a fixed detection temperature setpoint T_{D}. In common CAD systems the fixed, preset detection temperature setpoint may typically be T_{D}=40 °C. More particularly, the detection-temperature setpoint T_{D} may typically be factory set and not designed to be changed by a user. In other words, a user may typically not be able to change the detection-temperature setpoint in common state-of-the-art systems.

The ammeter 130 (or ampere meter 130) may typically also be temperature-controlled. In particular, the ammeter 130 may typically be temperature-dependent or respectively temperature-sensitive, e.g. because a resistance in the ammeter 130 may change with temperature. Thus, it may be advantageous to keep the temperature of the ammeter 130 stabilized to a fixed ammeter temperature setpoint T_{A} in order to avoid any temperature-induced changes to the measured current. This may enable detecting currents in the fA range. For the temperature stabilization of the ammeter to work reliably, the temperature should advantageously be kept above the temperature of adjacent components, particularly the detection assembly 120, to ensure sufficient independent control of the ammeter temperature. In common systems and particularly when the detection temperature setpoint T_{D} is chosen to be 40 °C, the fixed, preset ammeter temperature setpoint may be T_{A}=45 °C. That is, in such a case the ammeter 130 may be temperature-stabilised at 45 °C to enable sensitive detection in the fA range. More particularly, the ammeter-temperature setpoint T_{A} may typically be factory set and not designed to be changed by a user. In other words, a user may typically not be able to change the ammeter-temperature setpoint in common state-of-the-art systems. Since the ammeter is typically strongly temperature-dependent, a temperature difference of 5 °C compared to the detection assembly 120 may be required and/or sufficient for allowing a temperature stable ammeter.

Thus, the setpoint temperature may be increased by Δ_{T}=5 °C between drying tube 122, detection assembly 120 and ammeter 130, thereby providing a respective positive temperature gradient in a downstream direction. This may advantageously prevent any gas atmosphere saturated with eluents from condensing again.

That is, the drying tube 112, the detection assembly 120 and the ammeter 130 may each have their own independent temperature control 113, 128, 132 for stabilizing the temperature to a respective setpoint, i.e. desired value. The temperature control of the detection assembly 120 and the ammeter 130 may typically each be assigned with a respective fixed and preset temperature setpoint. As discussed above the detection temperature control 128 may typically be assigned a fixed detection temperature setpoint of T_{D}=40 °C, while the ammeter temperature control 132 may typically be assigned an ammeter temperature setpoint of T_{A}=45 °C. The standard preset value for the vaporization setpoint T_{V} of the drying-tube temperature control 113 may typically be T_{V}=35 °C. Thus, the temperature setpoints may increase in equal steps of Δ_{T}=5 °C in a downstream direction for each temperature control 113, 128, 132. Thus, with activated temperature stabilization (i.e. operating temperature controls 112, 128, 132) a positive temperature gradient may be established from drying tube 112 to the ammeter 130. This may advantageously reduce and ideally prevent recondensation of a saturated gas atmosphere and allow for very sensitive current detection with the ammeter 132.

The drying tube 112, the mixing chamber 122, the ion trap 124 and the collector 126 may also be referred to as aerosol-handling components since they interact with the aerosol while it is guided through the system 100. Owing to the temperature stabilization of the aerosol-handling components, the aerosol temperature may be controlled as it is guided through these components. Thus, controlling and stabilizing temperatures of aerosol-handling components allows to also control the aerosol temperature.

In common systems, the temperature setpoints T_{D}, T_{A} of the detection temperature control 128 and the ammeter temperature control 132 are each preset to a fixed value and generally kept constant. More particularly, these temperature setpoints may not be designed to be changed by a user. In contrast, the temperature of the drying tube 112 may be varied in a range from 5 °C to 100 °C. That is, the vaporization temperature setpoint T_{V} of the drying-tube temperature control 113 may be set to any value in the range of 5 °C to 100 °C.

However, if the vaporization temperature setpoint T_{V} is chosen to be above 40 °C, a negative temperature gradient may be established in the downstream direction since the detection temperature setpoint T_{D} may typically be preset to 40 °C. This may disadvantageously lead to an increased risk of recondensation of eluent. While a negative gradient may be desirable in specific circumstances, e.g. measuring a volatile analyte, it may generally not be desirable owing to the increased risk of recondensation.

In other words, if the drying tube 112 is operated at temperatures other than the standard value (typically 35 °C), for example to dry droplets faster or more thoroughly, the risk of recondensation may increase significantly for drying-tube temperatures (or vaporization temperature setpoints) above an operating temperature (or detection temperature setpoint) of the downstream detection assembly 120 (typically 40 °C) because the detection temperature setpoint may typically be fixedly set.

Again, an operating temperature of a temperature-controlled component may refer to the actual temperature of the component during operation, while the respective setpoint may denote the temperature setpoint of the corresponding temperature control. During normal operation of the respective temperature control the operating temperature may basically correspond to the associated temperature setpoint (apart from errors due to measurement uncertainties and manufacturing precision).

Generally, recondensation may only be determined empirically. This may mean that in certain applications the droplets cannot be dried at a higher drying-tube temperature. A solution to this problem is not possible as long as the detection unit is kept at a constant temperature (typically 40 °C). Additionally, the ammeter may also have to be kept at a constant temperature, namely 45 °C, at a certain distance from it.

Therefore, there may generally be a desire for prevention of recondensation of dried particles in saturated gas phases at drying-tube temperatures above the presently fixedly set operating temperature of downstream components.

With reference to FIG. 2 a CAD system 200 based on the present invention is shown, wherein like elements compared to the CAD system 100 discussed with respect to FIG. 1 carry like reference numerals.

The CAD system according to the present invention comprises an improved temperature-control system 300, which may generally be configured to allow for an interdependent temperature control of aerosol-handling components. In particular, it may be configured to keep a (typically positive) temperature gradient downstream of the drying tube 112 for an arbitrary vaporization temperature setpoint T_{V}, i.e. the temperature setpoint of the drying-tube temperature control 302.

The system 200 may generally be built like a CAD system 100 as known in the art (cf. FIG. 1). However, the drying-tube temperature control 302 may be operatively connected to the detection temperature control 320. This may advantageously allow the detection temperature control 320 to maintain an offset Δ_{T} between the detection temperature setpoint T_{D} and the vaporization temperature setpoint T_{V}. In other words, the temperature control 320 of the detection assembly 120 may follow the vaporization temperature setpoint T_{D} (and thus the drying-tube temperature) by an offset Δ_{T}, which may be adjustable. Thus, the temperature offsets of the drying-tube temperature control 302 and the detection temperature control 320 may always fulfil the following equation:

T_{D}=T_{V}+Δ_{T}.

The offset Δ_{T} may typically be in the range of −10 °C to +10 °C, wherein a standard offset may be +5 °C. The offset may be adjustable, e.g. by a user.

Thus, when a desired drying-tube temperature is chosen by setting the respective vaporization temperature setpoint T_{V} to the desired value, the detection temperature setpoint may automatically be adjusted such that the offset between the two setpoints is maintained.

Additionally, the ammeter 230 may be temperature-independent. Thus, changing the detection-assembly temperature does not affect measurements of the ammeter 230 even though the temperature of the ammeter 230 may also change due to heat transfer from the detection assembly.

Thus, the combination of a temperature-independent ammeter 230 and an improved detection temperature control 320 which is operatively connected to the drying-tube temperature control 302 and configured to automatically maintain a desired offset to the vaporization temperature setpoint, may advantageously allow for flexible temperature control of the drying-tube temperature while maintaining a desired temperature gradient in a downstream direction. This may for example allow for a reliable prevention of recondensation of dried aerosol owing to a negative temperature gradient in the analytical path of the CAD. It will be understood, that alternatively, the ammeter may be temperature-dependent and controlled such that its setpoint follows the detection temperature setpoint by the offset Δ_{T}. In other words, it may be kept Δ_{T} above the detection temperature setpoint.

Generally, the temperature controls 302, 320, 322, 324, 326 of the temperature control system 300 may be operatively connected to each other to allow for coordinated adjustment of temperature setpoints based on changing a changing a single temperature setpoint, e.g. by a user. The initially changed setpoint may also be referred to primary temperature setpoint while the other temperature setpoints may be referred to as dependent temperature setpoints.

The temperature controls 302, 320, 322, 324, 326 of the temperature control system 300 may further be configured to also provide cooling. Cooling may for example be realized using Peltier-Elements, which may be used for cooling and/or heating. Cooling may advantageously allow faster equilibration of a desired setpoint. Furthermore, it may advantageously allow temperatures below an ambient temperature, e.g. in hotter environments. This may generally be advantageous for measuring temperature-sensitive volatile substances. That is, cooling may advantageously allow to prevent drying of semi-volatile analyte particles at high temperatures. In this regard, the temperature control system 300 may also be configured to provide a negative temperature gradient, which may be desirable to avoid further drying of droplets/particles in the detection assembly 120, e.g. in case of very volatile analytes. While this may be disadvantageous with respect to recondensation, the present temperature control system 300 may at least allow to minimise an additionally increased risk of recondensation.

With respect to FIG. 3 a further embodiment of the present invention is discussed. In particular the temperature control system 300 may comprise individual temperature controls 322, 324, 326 for the mixing chamber 122, the ion trap 124, and the collector 126, respectively. In other words, the temperature control system 300 may comprise a mixing-chamber temperature control 322, an ion-trap temperature control 324, and a collector temperature control 326 in addition to the drying-tube temperature control 302. This may advantageously allow, to provide a more continuous and thus more precise temperature gradient in the downstream direction. The ionizer 121 may for example be stabilized to the same temperature as the mixing chamber 122, i.e. via the mixing-chamber temperature control 322.

For example, the respective setpoints may all be maintained with a predefined offset between subsequent temperature controls in the direction of flow (downstream direction). That is, a mixing-chamber temperature setpoint T_{M} of the mixing-chamber temperature control 322, an ion-trap temperature setpoint T_{I} of the ion-trap temperature control 324 and a collector temperature setpoint T_{C} of the collector temperature control 326 may automatically be controlled such that:

T_{M}=T_{V}+Δ_{T},

T_{I}=T_{M}+Δ_{T},

T_{C}=T_{I}+Δ_{T}.

This may advantageously allow to realise a desired positive (or optionally negative) temperature gradient downstream of the drying tube 112 (in the analytical path) even more precisely.

Additionally, also the ionizer, located at a separate inlet of the mixing chamber 122 may comprise its own temperature control (not shown) with its own setpoint. Alternatively and preferably, the ionizer may for example be temperature-controlled together with the mixing chamber, via the respective mixing-chamber temperature control 322. Temperature-stabilizing the ionizer 121 may generally allow to preheat the ionized gas before it is introduced in the mixing chamber and thus before it directly interacts with the aerosol.

With reference to FIG. 4 the present invention also relates to a method 10 for controlling temperatures in a CAD system. Very generally the method 10 may comprise the steps of setting a primary temperature setpoint (step 12), setting at least one dependent temperature setpoint (step 14) and stabilizing temperatures of components of the CAD system according to the associated temperature setpoints (step 16).

That is, in a first step 12 a primary temperature setpoint may be set. The primary temperature setpoint may typically correspond to the vaporization temperature setpoint of the drying-tube temperature controller 302 and thus to the desired drying-tube temperature. However, the primary temperature setpoint may generally be any temperature setpoint within the aerosol handling system. Typically, it may be desirable for a user to choose a drying-tube temperature since said temperature has an immediate effect on the aerosol handling, particularly it may determine how fast and to what extend aerosol droplets are dried in the drying tube 122. Thus, the primary temperature setpoint may be the vaporization temperature setpoint T_{V} associated with the drying-tube controller 302 and thus the drying-tube temperature.

Subsequently, based on the primary temperature setpoint T_{P} at least one dependent temperature setpoint is set (step 14). That is the dependent temperature setpoint may be set dependent on the primary temperature setpoint. For example, if the primary temperature setpoint is the vaporization temperature setpoint T_{V}, the at least one dependent temperature setpoint may comprise the detection temperature setpoint T_{D}.

Setting the at least one dependent temperature setpoint T_{S} may comprise establishing a respective pre-defined temperature difference between the primary temperature setpoint and the at least one dependent temperature setpoint. The pre-defined temperature difference may for example be defined by a desired temperature offset Δ_{T} between temperature setpoints of consecutive components in the CAD system with respect an aerosol flow direction. In particular, the pre-defined temperature difference may be defined such that the temperature setpoints associated with components adjacent in the aerosol flow direction differ by the temperature offset Δ_{T} such that the temperature setpoint is higher (or lower) when associated with the component further downstream in the aerosol flow direction, depending whether a positive temperature gradient or a negative temperature gradient is desired. Typically, a positive temperature gradient may be desired to lower the risk of recondensation. However, a negative temperature gradient may be desired in case of (semi-)volatile analytes.

In other words, considering i=1, . . . , n dependent temperature setpoints T_{Si} wherein T_{S1} corresponds to the temperature setpoint of a component directly downstream of the component associated with the primary temperature setpoint T_{P}, and T_{Sn+1} corresponds to the temperature setpoint of a component directly downstream of the component associated with the temperature setpoint T_{Si}, each dependent temperature setpoint may be given as

T_{Si}=T_{P}+I*Δ_{T},

for i=1, . . . , n, or similarly

T_{Si}=T_{S(i-1)}+Δ_{T},

for i=1, . . . , n and T₀=T_{P}.

The at least one temperature setpoint may be automatically set based on the primary temperature and the temperature offset Δ_{T}. Thus, a user may advantageously only set the primary temperature setpoint, e.g. a desired drying-tube temperature, and the at least one dependent temperature setpoint may be automatically set, such that the temperature offset Δ_{T} may be established between temperature setpoints associated with components that are adjacent in aerosol flow direction. In particular, the temperature setpoints may increase/decrease with respect to the aerosol flow direction, depending on the temperature offset being positive or negative. That is, a temperature setpoint associated with a component further downstream in the aerosol flow direction than another component may be higher/lower than a temperature setpoint associated with the other (more upstream) component.

It will be understood that the ionizer 121 is not immediately handling aerosol and thus also not considered to be “in aerosol flow direction”. Thus, if the ionizer is individually temperature controlled, it may for example be temperature controlled to the same setpoint as the drying tube or the micing chamber.

Once the temperature setpoints have be set, the temperatures of the system may be stabilized according to the setpoints. That is, the temperature controllers of the temperature control system may control and thus stabilize the temperature of associated system components. Once the temperatures are stabilized, a measurement may be performed.

Furthermore, the method may comprise using a temperature-independent ammeter 230. That is, the ammeter temp may not be controlled. This may allow to flexibly change the temperature of the detection assembly without affecting measurement properties of the ammeter 320.

With reference to FIG. 5 the method is described for a CAD system 200 as disclosed in FIG. 2. First, the vaporization temperature setpoint T_{V} of the drying-tube controller 302 may be set (step 21), e.g. by a user or alternatively it may for example also default to a preset value. Thus, the vaporization temperature setpoint T_{V} may constitute the primary temperature setpoint.

Secondly the detection temperature setpoint may be automatically set based on the vaporization temperature setpoint (step 23). In particular, the detection temperature T_{D} setpoint may be offset by temperature offset Δ_{T} with respect to the vaporization temperature T_{V} (T_{D}=T_{V}+Δ_{T}).

Furthermore, the method may comprise stabilizing the temperature of the drying tube 122 to the vaporization temperature setpoint T_{V} using the drying-tube temperature controller 302 (step 25) and, preferably simultaneously, stabilizing the temperature of the detection assembly to the detection temperature setpoint.

Once temperatures have been stabilized a measurement may be performed, in particular an aerosol may be generated and guided through the CAD system 200.

It will be understood that some of these method steps may be performed in parallel. For example, the drying-tube temperature may be stabilized immediately after setting the vaporization temperature setpoint and thus potentially in parallel with automatically setting the detection temperature setpoint.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. Method for controlling temperatures in a charged aerosol detector (CAD) system comprising a plurality of aerosol-handling components which are temperature controlled based on a respective temperature setpoint, the method comprising:
setting a primary temperature setpoint T_{P};
setting at least one dependent temperature setpoint based on the primary temperature setpoint; and
stabilizing temperatures of the temperature-controlled aerosol-handling components according to associated temperature setpoints.

2. The method according to claim 1, wherein the method comprises setting a temperature offset Δ_{T}, wherein setting the at least one dependent temperature setpoint is further based on the temperature offset Δ_{T}.

3. The method according to claim 1, wherein the method comprises establishing a temperature gradient between the temperature-controlled aerosol-handling components in an aerosol flow direction.

4. The method according to claim 1, wherein the CAD system comprises a temperature-independent ampere meter.

5. The method according to claim 1, wherein the temperature-controlled aerosol-handling components comprise a drying tube,
wherein the drying tube is temperature-controlled based on a vaporization temperature setpoint T_{V} of a drying-tube temperature controller, and
wherein the primary temperature setpoint is the vaporization temperature setpoint T_{V}.

6. The method according to claim 1, wherein the temperature-controlled aerosol-handling components comprise a mixing chamber, an ion trap, and a collector and wherein the system comprises a detection assembly comprising the mixing chamber, the ion trap, an ionizer, and the collector.

7. The method according to claim 6, wherein the detection assembly is temperature-controlled based on a single detection temperature setpoint T_{D} of a detection temperature controller and wherein the at least one dependent temperature setpoint comprises the detection temperature setpoint T_{D}.

8. The method according to claim 6, wherein
the mixing chamber is temperature-controlled based on a mixing-chamber temperature setpoint T_{M};
the ion trap is temperature-controlled based on an ion-trap temperature setpoint T_{I}; and
the collector is temperature-controlled based on a collector temperature setpoint T_{C}; and
wherein the at least one dependent temperature setpoint comprises the mixing-chamber temperature setpoint T_{M}, the ion-trap temperature setpoint T_{I}, and collector temperature setpoint T_{C}.

9. A charged aerosol detector (CAD) system, comprising
a drying tube;
a detection assembly comprising a mixing chamber, an ionizer, an ion trap, and a collector;
an ampere meter; and
a temperature control system comprising at least two temperature controllers,
wherein the temperature control system is configured to automatically control temperatures of the drying tube and the detection assembly and/or components thereof to provide a temperature gradient therebetween in a downstream direction.

10. The CAD system according to claim 9, wherein the temperature control system is configured to perform a method comprising:
setting a primary temperature setpoint T_{P};
setting at least one dependent temperature setpoint based on the primary temperature setpoint; and
stabilizing temperatures of the temperature-controlled aerosol-handling components according to associated temperature setpoints.

11. The CAD system according to claim 9, wherein the ampere meter is temperature independent.

12. The CAD system according to claim 9, wherein the temperature control system comprises a drying-tube temperature control configured to control a drying-tube temperature based on a vaporization temperature setpoint T_{V}.

13. The CAD system according to claim 12, wherein the temperature control system comprises a detection temperature control configured to control a detection temperature based on a detection temperature setpoint T_{D}, wherein the temperature control system is configured to automatically adjust the detection temperature setpoint T_{D} based on the vaporisation temperature setpoint T_{V}.

14. The CAD system according to claim 12, wherein the temperature control system comprises a mixing-chamber temperature control configured to control a mixing-chamber temperature based on a mixing-chamber temperature setpoint T_{M}, wherein the temperature control system 300 is configured to automatically adjust the mixing-chamber temperature setpoint T_{M} based on the vaporisation temperature setpoint T_{V}.

15. The CAD system according to claim 12, wherein the temperature control system comprises an ion-trap temperature control configured to control an ion-trap temperature based on an ion-trap temperature setpoint T_{I}, wherein the temperature control system is configured to automatically adjust the ion-trap temperature setpoint T_{I} based on the vaporisation temperature setpoint T_{V}.

16. The CAD system according to claim 12, wherein the temperature control system comprises a collector temperature control configured to control a collector temperature based on a collector temperature setpoint T_{C}, wherein the temperature control system is configured to automatically adjust the collector temperature setpoint T_{C} based on the vaporisation temperature setpoint T_{V}.

17. The CAD system according to claim 9, wherein the at least two temperature controllers of the temperature system are operatively connected to each other.

18. Computer program product comprising instructions which, when the program is executed by a CAD system according to claim 9, cause the CAD system to carry out a method comprising:
setting a primary temperature setpoint T_{P};
setting at least one dependent temperature setpoint based on the primary temperature setpoint; and
stabilizing temperatures of the temperature-controlled aerosol-handling components according to associated temperature setpoints.
